(19) United States
(12) Patent Application Publication
(10) Pub. No.: US 2012/0232762 A1
(43) Pub. Date: Sep. 13, 2012

(54) ELECTRONIC CONTROL SYSTEM FOR PAINT STRIPING VEHICLES

(75) Inventors: Marvin Lee Van Bruggen, Orange City, IA (US); Matthew Joseph Brossard, Orange City, IA (US)

(73) Assignee: EZ LINER, Orange City, IA (US)

(21) Appl. No.: 13/413,771

(22) Filed: Mar. 7, 2012

Related U.S. Application Data
(60) Provisional application No. 61/449,792, filed on Mar. 7, 2011.

(51) Int. Cl. G06F 17/00

(52) U.S. Cl. 701/49

(57) ABSTRACT

An electronic control system is provided for moving one or more paint carriages on a paint striping vehicle. The control system includes an electronic steering module, an electronic control module, a linear positioning transducer for each carriage, and a hydraulic control valve for each carriage. The steering module includes a rotatable wheel for extending and retracting the paint carriage without lost motion. A power switch and an emergency stop switch are provided for the system.

### CROSS-REFERENCE TO RELATED APPLICATIONS

This application claims priority under 35 U.S.C. §119 to provisional application Ser. No. 61/449,792 filed Mar. 7, 2011, herein incorporated by reference in its entirety.

### BACKGROUND OF THE INVENTION

Paint striping vehicles for painting stripes on roadways come in many varieties. One popular vehicle is a flat bed truck which has a driver in the front cab, and a striping operator in a rear cab. The striping equipment is carried between the cabs, such as one or more paint tanks, a glass bead tank, pumps mounted on the bed of the truck, and one or more paint spray nozzles mounted beneath the bed of the truck. The nozzles are normally carried on a cart or carriage which can be adjustably positioned vertically and laterally by hydraulics controlled by the operator in the rear truck cab. The controls in the rear cab typically include a large steering wheel and/or a joy stick for controlling the position of the spray nozzles through a mechanical-hydraulic interface. The truck usually includes left and right carriages with spray nozzles on each side of the truck, which can be operated separately or in unison.

U.S. Pat. Nos. 6,666,385 and 8,128,313 show the generally construction of a paint striping truck. One problem with these conventional striping vehicles is accuracy of the nozzle position. Another problem is slow adjustment of the cart and nozzle positions. The mechanical steering wheel or joy stick control of conventional striping vehicles lacks the accuracy desired for precision striping. The joy stick controllers also have a dead zone where any movement of the joy stick does not produce a corresponding movement in the nozzle cart or carriage.

Therefore, a primary objective of the present invention is the provision of an improved control system for positioning spray nozzle carriages on a paint striping vehicle.

Another objective of the present invention is the provision of an improved process for controlling paint striping of a paint striping vehicle.

A further objective of the present invention is the provision of an electric over hydraulic control system for quickly and easily adjusting the position of spray nozzle carts on a paint striping vehicle.

Still another objective of the present invention is the provision of an electronic control system for quickly and accurately positioning the paint carriage or carriages of a paint striping vehicle.

Yet another objective of the present invention is the provision of an electronic carriage positioning system and method which overcomes the problems of the prior art.

Another objective of the present invention is the provision of an electronic paint carriage control system for a paint striping vehicle, wherein the system includes a memory/recall feature which stores user defined paint carriage positions.

A further objective of the present invention is the provision of an electronic carriage positioning system for a paint striping vehicle wherein the system includes a keyed lock out switch and an emergency stop switch.

Still another objective of the present invention is the provision of an electronic control system for a paint striping vehicle which can be retrofit to control positioning of the paint carriages on the vehicle.

These and other objectives will become apparent from the following description of the invention.

### SUMMARY OF THE INVENTION

The electronic control system of the present invention is intended for use on a paint striping vehicle to control the positioning of the paint carriage or carriages on the vehicle. The system includes an electronic steering module, an electronic control module, a linear positioning transducer for each paint carriage, a hydraulic control valve for the hydraulic cylinder of each carriage, a keyed lock out switch, and an emergency stop switch. The electronic steering module includes carriage selection buttons for striping vehicles having more than one carriage, and a steering wheel for extending and retracting each carriage. The control module receives input signals from the steering module and sends output signals to the hydraulic control valves so as to move the carriages inwardly and outwardly. The linear transducers sense the position of the carriages, and send a signal to the control module. The transducers also permit an operator to set and recall carriage memory positions for the system via buttons on the steering module. The keyed switch turns power to the system on and off, and serves as a safety lock out for the system. When the emergency stop switch is actuated, all painting operations immediately cease, and then the paint carriages are returned to their raised and retracted positions on the paint truck as quickly as possible.

### BRIEF DESCRIPTION OF THE DRAWINGS AND PHOTOGRAPHS

FIG. 1 is a perspective view of one embodiment of a paint striping vehicle having the electronic control system of the present invention.

FIG. 2 is a schematic view of the control system of the present invention for adjusting the position of a paint carrier on a paint striping vehicle.

FIG. 3 is another schematic view of the control system.

FIG. 4 is a perspective view of the steering module for the control system.

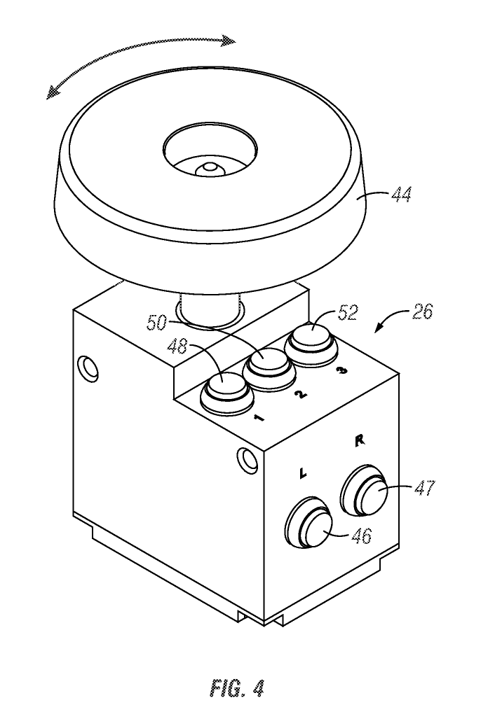

### DETAILED DESCRIPTION OF THE PREFERRED EMBODIMENTS

The present invention is directed to an electronic control system and process for adjusting the position of the paint spray nozzle cart on a paint striping vehicle by an operator in the vehicle. More particularly, the conventional mechanical system, including the large steering wheel, which controls the hydraulic movement of the paint cart in a striping vehicle, is replaced with an electro-hydraulic system for improved control of the position of the paint striping carriages.

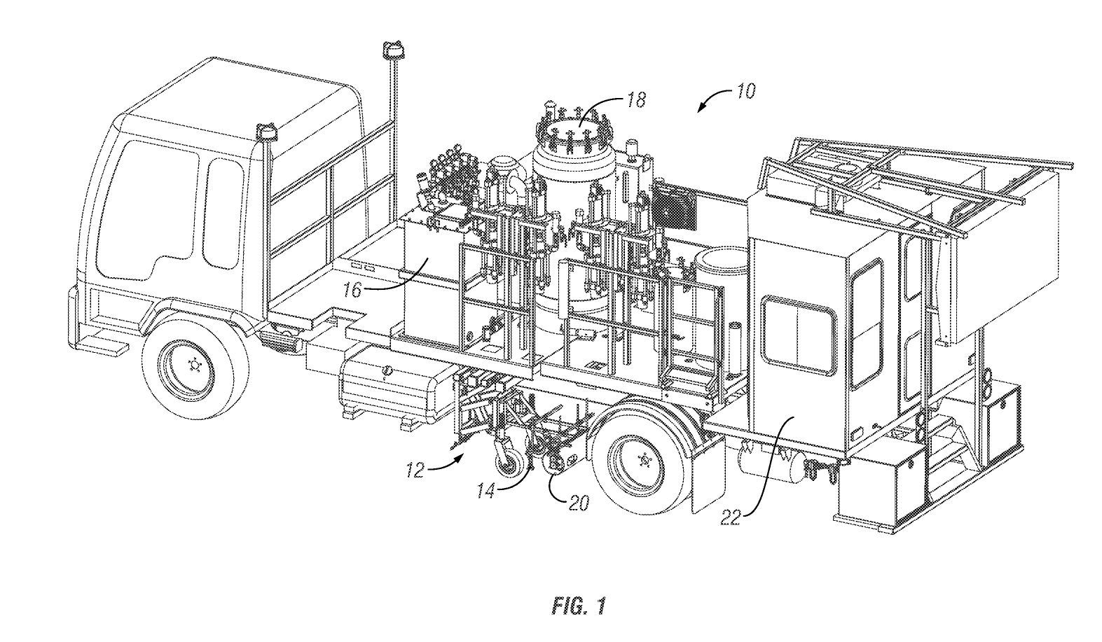

FIG. 1 shows an example of a paint striping vehicle 10 having a paint carriage 12 mounted beneath the vehicle for vertical and horizontal movement. Typically, there is a carriage 12 on each side of the vehicle 10. Each carriage 12 includes a spray nozzle 14 for applying a paint stripe to a road surface. Movement of the carriage 12 is created by extension and retraction of an arm of a hydraulic cylinder 13. The nozzle 14 is operatively connected to a paint storage tank or vessel 16 on the vehicle 10. The vehicle 10 may also include a pressurized tank or vessel 18 for storing reflective particles, such as glass beads, which may be applied to the paint stripe via a bead dispenser 20, to add reflectivity to the paint stripe. The vehicle 10 also includes a rear cab 22 for an operator who controls the spraying operation of the vehicle 10.

The above description of the paint vehicle 10 is conventional, and is not a part of the present invention.

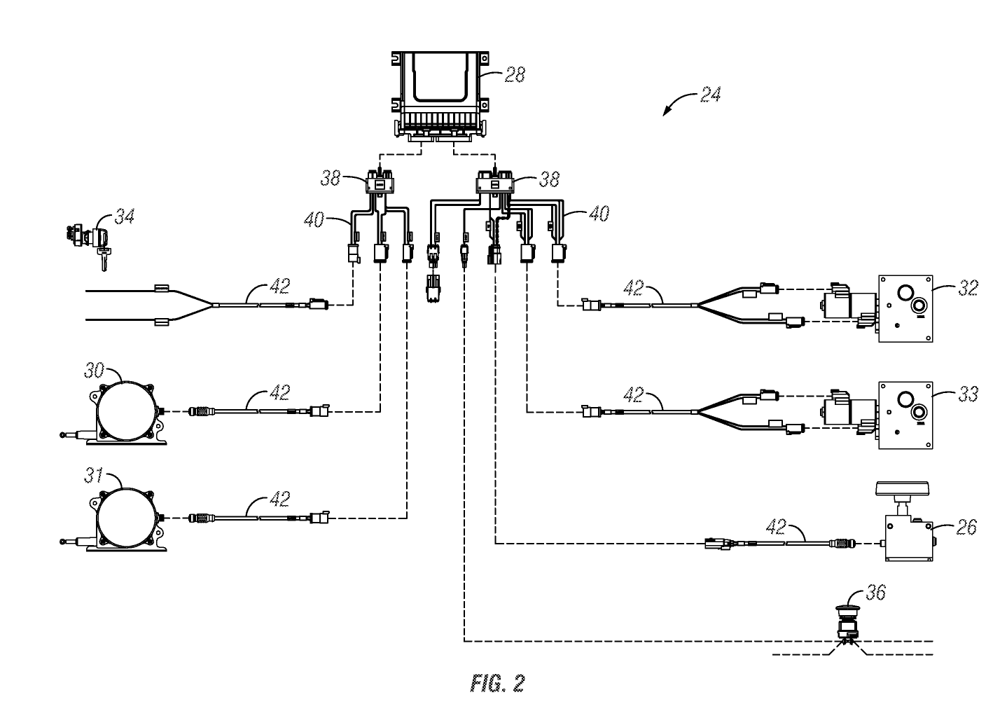

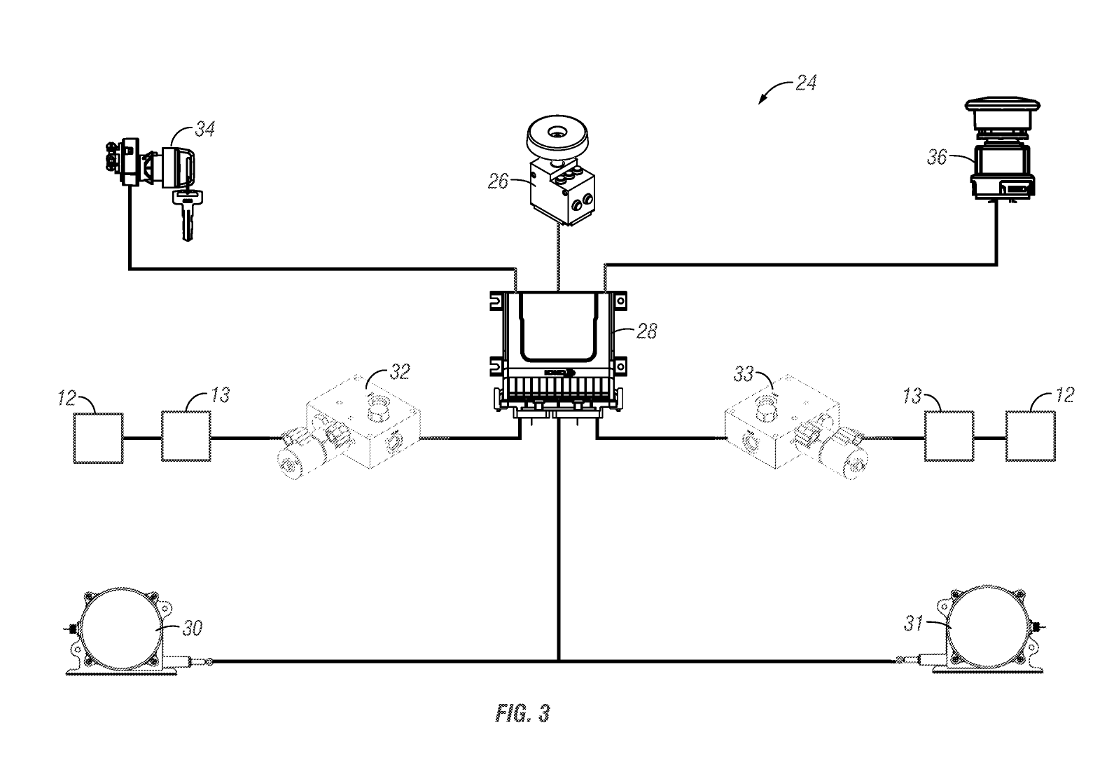

The electronic control system of the present invention is shown schematically in FIGS. 2 and 3 of the drawings. The control system is generally designated by the reference numeral 24, and preferably as mounted in the rear cab 22 of the vehicle 10. The control system 24 includes an electronic steering module 26, and an electronic control module 28, an electronic linear measuring device 30 for each carriage 12, a hydraulic control valve 32, a master key lock out switch 34, and an emergency stop switch 36. Each control valve 32 is operatively connected to the hydraulic cylinder 13 of the paint carriage 12.

The electronic linear measuring device 30 is also known as a linear position transducer, a linear position sensor, a linear position encoder, a linear encoder, a linear encoder, a linear transducer, or a linear sensor.

It is understood from FIGS. 2 and 3 that the various components of the control system 24 are operatively coupled with appropriate electrical wires, wire harnesses, and/or cable connections. For example, pin connectors 38 with conventional input and output connections may be provided for the wiring harnesses 40, which in turn may have appropriate connections for cables 42.

The linear positioning device 30 is mounted to the cart or carriage 12 so as to protect the device from damage. Preferably, the electronic linear positioning device will have travel capability of up to 8′ (96″), so as to accommodate the full and potential travel distance of present and future paint cart configurations.

The electronic steering module 26 is mounted in the rear cab 22, adjacent the operator's seat. The steering module 26 has a small wheel 44 rotatable in opposite directions so as to extend and retract the paint carriage 12 via the linear measuring device 30 and the conventional hydraulic cylinder. The control wheel 44 has infinite turning ability, with any movement in either the clockwise or counterclockwise direction resulting in an extension or retraction of the cart position relative to the vehicle frame.

The control system 24 provides a direct proportional movement between the wheel 44 and the paint carriage 12. Slow rotation of the control wheel 44 by the operator will produce small, slow accurate extension and retraction of the carriage 12, while rapid and aggressive rotation of the control wheel 44 by the operator will result in a rapid, yet accurate extension and retraction of the carriage 12. This direct relationship between the wheel 44 and the cart or carriage 12 movement is achieved without lost movement or a dead zone, as in conventional mechanical/hydraulic control systems.

The steering module 26 also includes a plurality of buttons or switches for the operator to selectively control movement of the left hand and right hand paint carriages or carts 12. More particularly, a first button 46 controls the left carriage, while a second button 47 controls the right carriage on the paint striping vehicle 10. A plurality of memory buttons 48, 50, 52 may also be provided on the steering module 26. While three memory buttons are shown, it is understood that fewer or more buttons may be provided.

The system 24 can be calibrated after installation on the striping vehicle 10. The calibration need only be done one time, and once completed, does not have to be repeated. Preferably, the calibration sets the minimum and maximum cart retraction and extension, respectively. First, the left or right carriage button 46, 47 is depressed to select which carriage is being calibrated. When the left button 46 is actuated for calibrating the left carriage 12, the wheel 44 is rotated clockwise to fully retract the carriage 12. Then, buttons 50, 52 are depressed simultaneously for three seconds to set the full retraction limit for the left carriage. Then, the wheel 44 is rotated counterclockwise to fully extend the left carriage 12. The buttons 48, 50 are then depressed for three seconds to set this maximum extension of the left carriage.

When the right button 47 is depressed to select the right carriage 12 on the paint striping vehicle 10, the wheel 44 is rotated counterclockwise to fully retract the carriage 12, and then the buttons 48, 50 are depressed simultaneously for three seconds to set the retraction limit. The wheel 44 is rotated clockwise to fully extend the carriage 12, and then the buttons 50, 52 are simultaneously depressed for three seconds to set the full extension of the right carriage 12.

During use, the operator can control the position of the left and right carriages by selecting the buttons 46, 47, and then rotating the wheel 44 to position the carriage 12 at the desired location relative to the vehicle 10. The rotation of the wheel 44 is intuitive, in that extension of the left carriage is accomplished by rotating the wheel 44 in a counterclockwise direction, while extension of the right carriage is accomplished by rotating the rotating the wheel 44 in a clockwise direction. Retraction of the left and right carriages are accomplished by rotating the wheel 44 in a clockwise and counterclockwise direction, respectively.

The memory buttons 48, 52 can be actuated to move the carriages to user defined memory positions. The memory buttons are intuitive with respect to the selected left or right carriage and movement of the carriages inwardly and outwardly on the vehicle 10 to user defined memory positions.

The emergency stop button 36 will automatically and immediately terminate all painting functions and has the capability to return the cart or carriage 12 to a home position wherein the cart or carriage 12 is fully raised and retracted. The keyed lock out switch 34 provides power to the system 24 when the key is turned on and shuts off power when the key is turned off. This lock out switch 34 enhances safety during maintenance and other work on the cart or carriage 12.

With the control system 24 of the present invention, the prior art large steering wheel and associated hydraulic hoses in prior art paint striping vehicles is eliminated, thus providing more space for the operator in the rear cab 22, and reducing the potential safety issues relative to high pressure hydraulic hoses and devices located in close proximity to the operator.

The electric over hydraulic linear positioning control system 24 provides control of the cart position within 0.25 inch repeatability. The cart position will have a closed loop control back to the operator's control wheel 44.

The control system 24 provides greatly enhanced control and accuracy of the cart or carriage 12 position through the exact position control of the hydraulic cylinder arm. The cart or carriage 12 can be quickly retracted when approaching obstacles, such as bridges, road signs, and the like. The ability to have one or more user defined striping positions for the cart or carriage 12 is also an improvement over the prior art. The system 24 also improves safety in the operator's cab by eliminating high-pressure hydraulic steering hoses.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. An improved paint striper vehicle, comprising:
a paint cart mounted on the vehicle for spraying a paint stripe on a roadway;
a hydraulic cylinder connected to the cart and having an extendable and retractable arm to adjust the position of the cart; and
an electric over hydraulic control system operatively connected to the hydraulic cylinder for an operator in the vehicle to control the position of the cart.

2. The improved paint striper vehicle of claim 1 wherein the control system includes an electronic steering wheel module in the vehicle for an operator to adjust the cart position.

3. The improved paint striper vehicle of claim 2 wherein movement of the cart is directly proportional to movement of the steering wheel module.

4. The improved paint striper vehicle of claim 1 wherein the control system includes a switch to move the cart to a user defined position.

5. The improved paint striper vehicle of claim 1 wherein the control system includes switches for a plurality of user defined cart positions.

6. The improved paint striper vehicle of claim 1 wherein the control system includes an electronic linear measuring device.

7. The improved paint striper vehicle of claim 1 wherein the control system includes an emergency stop switch.

8. The improved paint striper vehicle of claim 1 wherein the control system includes an electronic control module, a transducer operatively connected to the control module, a valve operatively connected to the control module, and a steering module operatively connected to the control module.

9. The improved paint striper vehicle of claim 8 wherein the control module receives input signals from the steering module and sends an output signal to the transducer.

10. The improved paint striper vehicle of claim 8 further comprising a keyed on/off switch operatively connected to the control module.

11. An improved method of controlling a paint cart on a paint striper vehicle, the vehicle including a hydraulic cylinder with an extendable and retractable arm connected to the cart, the method comprising:
actuating an electronic control system operatively connected to the paint cart to control movement and positioning of the paint cart.

12. The improved method of claim 11 wherein the control system includes a steering wheel operatively connected to a linear transducer, which is operatively connected to the cart, and the method further comprising rotating the wheel in opposite directions to control the transducer so as to control the cart position.

13. The improved method of claim 12 further comprising moving the cart in direct proportion to rotation of the wheel.

14. The improved method of claim 11 further comprising moving the cart to a user defined position by actuating a button on the control system.

15. The improved method of claim 11 further comprising a stop switch to retract and raise the cart.

16. The improved method of claim 11 further comprising actuating a stop switch to move the cart to a home position.

17. An electronic control system for moving left and right paint carriages of a paint striper vehicle, comprising:
an electronic steering wheel selectively coupled to the carriages, whereby rotation of the wheel in a clockwise direction retracts the left carriage and extends the right carriage, and rotation of the wheel in a counterclockwise direction extends the left carriage and retracts the right carriage.

18. The electronic control system of claim 17 further comprising at least one switch to selectively couple the wheel between the left and right carriages.
